(19) United States
(12) Patent Application Publication
(10) Pub. No.: US 2006/0204858 A1
(43) Pub. Date: Sep. 14, 2006

(54) Non-aqueous electrolyte secondary cell

(75) Inventors: Koji Hasumi, Kobe-shi (JP); Kentaro Takahashi, Sumoto-shi (JP); Takao Nishitani, Sumoto-shi (JP); Hiromitsu Suwa, Sumoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/367,276

(22) Filed: Mar. 6, 2006

(30) Foreign Application Priority Data
Mar. 8, 2005 (JP) 2005-064019
Jan. 18, 2006 (JP) 2006-010171

(51) Int. Cl. H01M 6/16

(52) U.S. Cl. 429/342

(57) ABSTRACT

It is an object of the present invention to provide a non-aqueous electrolyte secondary cell that is excellent in high-temperature preservation characteristics and in which an increase in the cell thickness is inhibited. The object is accomplished by the following structure. A non-aqueous electrolyte secondary cell having: a positive electrode; a negative electrode; a non-aqueous electrolyte having a non-aqueous solvent and an electrolytic salt; and an outer casing for housing the positive electrode, the negative electrode, and the non-aqueous electrolyte. The non-aqueous solvent has propylene carbonate at from 10 to 60 volume %. The non-aqueous electrolyte further has, as well as the non-aqueous solvent, vinyl acetate at from 0.3 to 3.0 mass % and vinyl ethylene carbonate at from 1.0 to 3.5 mass %.

### BACKGROUND OF THE INVENTION

1) Field of the Invention

The present invention relates to non-aqueous electrolyte secondary cells, and particularly to an improvement of the high-temperature preservation characteristics.

2) Description of the Related Art

In recent years, there has been a rapid reduction in the size and weight of mobile information terminals such as mobile phones, notebook personal computers, PDAs, and the like. As the driving sources for them, non-aqueous electrolyte secondary cells such as lithium ion secondary cells, which have high energy density and high capacity, are widely used. Recently, further more reliable non-aqueous electrolyte secondary cells are in demand such that even when used or preserved under environments of high temperature, there is no expansion and no decrease in discharge capacity.

Techniques for improving the performance of non-aqueous electrolyte secondary cells are proposed in, for example, patent documents 1 and 2.

Patent Document 1: Japanese Patent Application Publication No. 2000-223154 (Abstract, claims).

Patent Document 2: Japanese Patent Application Publication No. 2001-6729 (Abstract, claims).

These documents are summarized as follows.

(i) The technique involved in patent document 1 is one using, as the positive electrode active material, spinel-type lithium-manganese oxide, and containing, in the non-aqueous electrolyte, a polymerizable organic compound such as vinyl acetate. It is said that with this technique, the polymerizable organic compound forms a coating film on the surface of the lithium-manganese oxide, and the coating film then alleviates the oxidation of the lithium-manganese oxide, thereby inhibiting the decomposition of the electrolytic solution and self-discharging.

(ii) The technique involved in patent document 2 is one containing, in the non-aqueous solvent, vinyl ethylene carbonate. It is said that with this technique, the vinyl ethylene carbonate forms a stable coating film on the surface of the negative electrode to inhibit the decomposition of the electrolytic solution, thereby improving the preservation characteristics of cells under environments of high temperature.

However, these techniques still cannot provide a sufficient improvement of the high-temperature characteristics of non-aqueous electrolyte secondary cells.

### SUMMARY OF THE INVENTION

In view of the foregoing and other problems, it is an object of the present invention to provide a non-aqueous electrolyte secondary cell excellent in preservation characteristics under high temperature.

In order to accomplish the above and other objects, the present invention is configured as follows.

A non-aqueous electrolyte secondary cell comprising: a positive electrode; a negative electrode; a non-aqueous electrolyte having a non-aqueous solvent and an electrolytic salt; and an outer casing for housing the positive electrode, the negative electrode, and the non-aqueous electrolyte, wherein: the non-aqueous solvent has propylene carbonate at from 10 to 60 volume %; and the non-aqueous electrolyte further has, as well as the non-aqueous solvent, vinyl acetate at from 0.3 to 3.0 mass % and vinyl ethylene carbonate at from 1.0 to 3.5 mass %.

In this structure, propylene carbonate (PC) is contained in the non-aqueous solvent, and because the PC has the effect of enhancing discharge characteristics, by containing PC, a non-aqueous electrolyte secondary cell also excellent in the discharge characteristics is obtained.

However, when PC is contained in the non-aqueous solvent, the PC is decomposed intensely on the surface of the negative electrode, presenting such a problem that the intercalation/deintercalation of the lithium at the negative electrode cannot proceed smoothly. In order to solve this problem, the above-described present invention employs such a structure that the non-aqueous electrolyte further has vinyl acetate (VA) and vinyl ethylene carbonate (VEC). The VA and VEC form stable coating films of good quality on the surface of the negative electrode, and the coating films inhibit the reaction between the PC and the negative electrode, thereby realizing a non-aqueous electrolyte secondary cell that does not deteriorate when preserved under high temperature.

It is noted that when only either VA or VEC is contained, the coating film formed on the negative electrode becomes unstable, making it impossible to sufficiently inhibit the reaction between the PC and the negative electrode.

If the amount of addition of the PC is excessively small, the discharge characteristics cannot be enhanced sufficiently, and if the amount is excessively large, even if the VA and VEC are contained, the decomposition reaction of the PC on the negative electrode occurs. In view of this, the amount addition of the PC is preferably restricted within the above-mentioned range. More preferably, the amount of addition of the PC is from 20 to 40 volume %.

Also, if the amounts of addition of the VA and VEC are excessively small, the decomposition of the PC cannot be inhibited sufficiently, and if the amounts are excessively large, the coating films resulting from the VA and VEC become dense, resulting in the effect of interrupting the discharge reaction at the negative electrode. In view of this, the amounts of addition of the VA and VEC are preferably restricted within the above-mentioned ranges, and more preferably, the amount of addition of the VA is from 0.5 to 2.0 mass %, and the amount of addition of the VEC is from 1.5 to 3.5 mass %.

In addition, if, as the outer casing, a film outer casing composed of a metal layer and a resin layer laminated atop one another is used, the mass and volume of the outer casing are decreased, thereby enhancing the mass energy density and volume energy density of the cell.

### DESCRIPTION OF THE PREFERRED EMBODIMENTS

Preferred embodiments of the present invention will be described below. It will be appreciated that the present invention will not be limited to the examples below, and that any practice of the invention with suitable amendments is possible without departing from the scope of the invention.

### EXAMPLE 1

<Preparation of the Positive Electrode>

Ninety parts by mass of the positive electrode active material made of LiCoO₂, 5 parts by mass of carbon powder as a conductive agent, 5 parts by mass of polyvinylidene fluoride (PVdF) as a binder, and N-methyl-pyrrolidone were mixed, thus obtaining a positive electrode active material slurry. This positive electrode active material slurry was applied on both surfaces of a positive electrode current collector (15 μm thick) made of aluminum, dried, and compressed, thus preparing a positive electrode. Then, a positive electrode lead was attached thereto.

<Preparation of the Negative Electrode>

Ninety five parts by mass of graphite as a negative electrode active material, 3 parts by mass of carboxy methyl cellulose as a thickening agent, 2 parts by mass of styrene butadiene rubber as a binder, and water were mixed together, thus obtaining negative electrode active material slurry. This negative electrode active material slurry was applied on both surfaces of a negative electrode current collector (8 μm thick) made of copper, dried, and compressed, thus preparing a negative electrode. Then, a negative electrode lead was attached thereto.

<Preparation of Electrode Assembly>

An electrode assembly was prepared by winding The positive electrode and the negative electrode were wound with in between a separator made of a microporous film of polypropylene, and then pressed, thus preparing a flat wound electrode assembly.

<Preparation of the Electrolytic Solution>

As a non-aqueous solvent, ethylene carbonate (EC), propylene carbonate (PC), and diethyl carbonate (DEC) were mixed at a volume ratio of 40:20:40 under the conditions of 25° C. and 1 atm. As electrolytic salt, LiPF₆ was dissolved in the non-aqueous solvent at 1 M (mole/liter). Added therein were vinyl ethylene carbonate (VEC) at 2.0 mass % and vinyl acetate (VA) at 0.5 mass %. Thus, an electrolytic solution was obtained.

<Assembly of the Cell>

After preparing a sheet laminate material of five-layered structure composed of a resin layer (polypropylene)/adhesive layer/aluminum alloy layer/adhesive layer/resin layer (polypropylene), the areas around the end portions of the resin layers were superposed, and the portions of the superposition was welded. Next, into the disposing space of the resultant cylindrical aluminum laminate material, the electrode assembly was inserted. On this occasion, the electrode assembly was disposed such that the positive electrode lead and negative electrode lead would protrude from one opening portion of the cylindrical aluminum laminate material. Then, the inner-side resin layer at the opening portion through which the electrode tabs protruded was welded and sealed, thus forming a sealed portion. On this occasion, the welding was carried out using a high-frequency induction welder. After inserting the electrolytic solution from the other opening portion, this opening portion was likewise heated and welded. Thus, a non-aqueous electrolyte secondary cell according to example 1 with a theoretical capacity of 700 mAh was prepared.

### EXAMPLE 2

A non-aqueous electrolyte secondary cell according to example 2 was prepared in the same manner as example 1 except that the VEC was 1.5 mass % and the VA was 1.0 mass %.

### COMPARATIVE EXAMPLE 1

A non-aqueous electrolyte secondary cell according to comparative example 1 was prepared in the same manner as example 1 except that the VEC was 2.5 mass % and the VA was 0.0 mass %.

### COMPARATIVE EXAMPLE 2

A non-aqueous electrolyte secondary cell according to comparative example 2 was prepared in the same manner as example 1 except that the VEC was 0.0 mass % and the VA was 2.5 mass %.

Each of the above-prepared cells was subjected to a cycle characteristics test under the following conditions. The amount of increase in the thickness of each cell after the cycle characteristics test was measured. The results are shown in Table 1.

<80° C. Charge Preservation Test>

Each of the above-prepared cells was subjected to initial charging and discharging such that charging was at a constant current of 1 I t (700 mA) up to 4.2 V, and discharging was at a constant current of 1 I t (700 mA) up to 2.75 V, and the initial discharging capacity of each cell was measured. Then, each cell was charged at a constant current of 1 I t (700 mA) up to 4.2 V, and preserved in the charged state for 5 days (120 hrs) at 80° C. Then, after measuring the amount of expansion of each cell after preservation, each cell was cooled to 25° C., and the amount of cell expansion after cooling was measured. Then, each cell after cooling was discharged at a constant current of 1 I t (700 mA) up to 2.75 V, and the remaining discharge capacity of each cell was measured. Each cell after discharging was again charged and discharged under the same conditions as the initial charging and discharging, and the regained discharge capacity of each cell was measured. From this discharge capacity, the preservation characteristics of each cell were calculated using the following formulas. The results are shown in Table 1.
Remaining preservation characteristics (%)=remaining discharge capacity÷initial discharge capacity×100
Regained preservation characteristics (%)=regained discharge capacity÷initial discharge capacity×100

<60° C. Charge Preservation Test>

Each of the above-prepared cells was subjected to initial charging and discharging, and then charged at a constant current of 1 I t (700 mA) up to 4.2 V, and preserved in the charged state for 20 days (480 hrs) at 60° C. Then, each cell was cooled to 25° C., and the amount of cell expansion after preservation was measured. Then, each cell after cooling was discharged at a constant current of 1 I t (700 mA) up to 2.75 V, and the remaining discharge capacity of each cell was measured. Each cell after discharging was again charged and discharged under the same conditions as the initial charging and discharging, and the regained discharge capacity of each cell was measured. From this discharge capacity, the preservation characteristics of each cell were calculated in the above-described manner. The results are shown in Table 2.

<60° C. Discharge Preservation Test>

Each of the above-prepared cells was subjected to initial charging and discharging, and preserved in the discharged state for 20 days (480 hrs) at 60° C. Then, each cell was cooled to 25° C., and the amount of cell expansion after preservation was measured. Each cell after cooling was again charged and discharged under the same conditions, and the regained discharge capacity of each cell was measured. From this discharge capacity, the preservation characteristics of each cell were calculated in the above-described manner. The results are shown in Table 3.

TABLE 1

| | | | | The | | |
|---|---|---|---|---|---|---|
| | The | The | The amount | amount of | | |
| | amount of | amount of | of expansion | expansion | Remaining | Regained |
| | addition of | addition of | after | after | preservation | preservation |
| | VEC | VA | preservation | cooling | characteristics | characteristics |
| | (mass %) | (mass %) | (mm) | (mm) | (%) | (%) |
| Ex. 1 | 2.0 | 0.5 | 0.044 | 0.036 | 86.6 | 94.0 |
| Ex. 2 | 1.5 | 1.0 | 0.049 | 0.039 | 84.9 | 92.9 |
| Com. | 2.5 | 0.0 | 0.391 | 0.089 | 82.4 | 89.7 |
| Ex. 1 | | | | | | |
| Com. | 0.0 | 2.5 | 0.186 | 0.051 | 74.3 | 87.1 |
| Ex. 2 | | | | | | |

TABLE 2

| | The | The | | Remaining | Regained |
|---|---|---|---|---|---|
| | amount of | amount of | The amount | preservation | preservation |
| | addition of | addition of | of expansion | char- | char- |
| | VEC | VA | after cooling | acteristics | acteristics |
| | (mass %) | (mass %) | (mm) | (%) | (%) |
| Ex. 1 | 2.0 | 0.5 | 0.002 | 87.7 | 94.9 |
| Ex. 2 | 1.5 | 1.0 | 0.013 | 84.8 | 93.7 |
| Com. | 2.5 | 0.0 | 0.037 | 86.4 | 93.6 |
| Ex. 1 | | | | | |
| Com. | 0.0 | 2.5 | 0.048 | 70.1 | 83.1 |
| Ex. 2 | | | | | |

TABLE 3

| | The | The | | |
|---|---|---|---|---|
| | amount of | amount of | The amount | Regained |
| | addition of | addition of | of expansion | preservation |
| | VEC | VA | after cooling | characteristics |
| | (mass %) | (mass %) | (mm) | (%) |
| Ex. 1 | 2.0 | 0.5 | 0.019 | 99.3 |
| Ex. 2 | 1.5 | 1.0 | 0.024 | 99.6 |
| Com. | 2.5 | 0.0 | 0.097 | 96.7 |
| Ex. 1 | | | | |
| Com. | 0.0 | 2.5 | 10.013 | — |
| Ex. 2 | | | | |

In Table 3 above, since in comparative example 2 only VA was added, internal resistance increased because of the decomposition of the electrolytic solution and capacity measurement was impossible to carry out.

From Table 1, it can be seen that in examples 1 and 2, in which vinyl ethylene carbonate (VEC) and vinyl acetate (VA) were contained, the amounts of expansion after preservation, respectively 0.044 mm and 0.049 mm, and the amounts of expansion after cooling, respectively 0.036 mm and 0.039 mm, were smaller than those in comparative examples 1 and 2, in which either VEC or VA was contained and the amounts of expansion after preservation were respectively 0.391 mm and 0.186 mm and the amounts of expansion after cooling were respectively 0.089 mm and 0.051 mm.

This can be considered as follows. The VEC and VA react with the negative electrode to form coating films that inhibit the reaction between the electrolytic solution and the negative electrode, and this effect cannot be obtained with either one of them. Therefore, in the cells of comparative examples 1 and 2, the electrolytic solution reacts with the negative electrode and decomposes, and thus, the cell expands greatly. On the other hand, if the VEC and VA are used in mixture, coating films of good quality are formed on the negative electrode, and the coating films sufficiently inhibit the reaction between the electrolytic solution and the negative electrode, and thus, the cell has substantially no expansion.

It can also be seen from Table 1 that in examples 1 and 2, in which vinyl ethylene carbonate (VEC) and vinyl acetate (VA) were contained, the remaining preservation characteristics, respectively 86.6% and 84.9%, and the regained preservation characteristics, respectively 94.0% and 92.9%, were superior to those in comparative examples 1 and 2, in which either VEC or VA was contained and the remaining preservation characteristics were respectively 82.4% and 74.3% and the regained preservation characteristics were respectively 89.7% and 87.1%.

This can be considered as follows. If the electrolytic solution and the negative electrode react with each other, the amount of the electrolytic solution decreases, and the decomposition product causes the internal resistance of the cell to increase, resulting in a decrease in the discharge capacity. Therefore, in comparative examples 1 and 2, the preservation characteristics decrease. On the other hand, in examples 1 and 2, because of the VEC and VA, the electrolytic solution and the negative electrode do not react with each other, and thus, the above problem does not occur.

From Table 2, it can be seen that in examples 1 and 2, in which vinyl ethylene carbonate (VEC) and vinyl acetate (VA) were contained, the amounts of cell expansion after cooling were respectively 0.002 mm and 0.013 mm, which were smaller than 0.037 mm and 0.048 mm respectively for comparative examples 1 and 2, in which either vinyl ethylene carbonate (VEC) or vinyl acetate (VA) was contained.

It is considered that this is because of the same reasons discussed with respect to Table 1 above.

It can also be seen from Table 2 that in examples 1 and 2, in which vinyl ethylene carbonate (VEC) and vinyl acetate (VA) were contained, the remaining preservation characteristics were respectively 87.7% and 84.8% and the regained preservation characteristics were respectively 94.9% and 93.7%, which were superior to the 70.1% remaining preservation characteristics and the 83.1% regained preservation characteristics of comparative example 2, in which only vinyl acetate was contained. Also, in comparative example 1, in which only vinyl ethylene carbonate was contained, the remaining preservation characteristics were 86.4% and the regained preservation characteristics were 93.6%, which were not significantly different from those in examples 1 and 2.

It can also be seen from Tables 2 and 3 that in examples 1 and 2 and comparative examples 1 and 2, the amounts of expansion after cooling were larger in preservation in the discharged state than in the charged state. It can also be seen that in examples 1 and 2 and comparative example 1, the regained preservation characteristics were greater in preservation in the discharged state than in the charged state.

### EXAMPLE 3

A non-aqueous electrolyte secondary cell according to example 3 was prepared in the same manner as example 1 except that the vinyl acetate (VA) was 0.3 mass %.

### EXAMPLE 4

A non-aqueous electrolyte secondary cell according to example 4 was prepared in the same manner as example 3 except that the VA was 1.0 mass %.

### EXAMPLE 5

A non-aqueous electrolyte secondary cell according to example 5 was prepared in the same manner as example 3 except that the VA was 2.0 mass %.

### EXAMPLE 6

A non-aqueous electrolyte secondary cell according to example 6 was prepared in the same manner as example 3 except that the VA was 3.0 mass %.

### COMPARATIVE EXAMPLE 3

A non-aqueous electrolyte secondary cell according to comparative example 3 was prepared in the same manner as example 3 except that the VA was not contained (the amount of addition thereof was 0.0 mass %).

### COMPARATIVE EXAMPLE 4

A non-aqueous electrolyte secondary cell according to comparative example 4 was prepared in the same manner as example 3 except that the VA was 0.2 mass %.

### COMPARATIVE EXAMPLE 5

A non-aqueous electrolyte secondary cell according to comparative example 5 was prepared in the same manner as example 3 except that the VA was 3.5 mass %.

Each of the above-prepared cells was subjected to a high-temperature characteristics test under the above conditions. The results are shown in Table 4.

TABLE 4

| | | Amount of | Amount of | Remaining | Regained |
|---|---|---|---|---|---|
| | Amount of | expansion | expansion | preservation | preservation |
| | addition of | after | after | char- | char- |
| | VA | preservation | cooling | acteristics | acteristics |
| | (mass %) | (mm) | (mm) | (%) | (%) |
| Com. | 0.0 | 0.399 | 0.091 | 81.8 | 89.9 |
| Ex. 3 | | | | | |
| Com. | 0.2 | 0.402 | 0.099 | 82.4 | 89.8 |
| Ex. 4 | | | | | |
| Ex. 3 | 0.3 | 0.143 | 0.045 | 85.5 | 93.8 |
| Ex. 1 | 0.5 | 0.044 | 0.036 | 86.6 | 94.0 |
| Ex. 4 | 1.0 | 0.040 | 0.035 | 86.9 | 95.5 |
| Ex. 5 | 2.0 | 0.038 | 0.031 | 86.8 | 95.0 |
| Ex. 6 | 3.0 | 0.037 | 0.032 | 85.4 | 93.4 |
| Com. | 3.5 | 0.038 | 0.030 | 80.2 | 88.0 |
| Ex. 5 | | | | | |

From Table 4, it can be seen that in comparative examples 3 and 4, in which the vinyl acetate (VA) content was 0.2 mass % or smaller, the amounts of expansion after preservation were respectively 0.399 mm and 0.402 mm and the amounts of expansion after cooling were respectively 0.091 mm and 0.099 mm, which were larger than the 0.037-0.143 mm amounts of expansion after preservation and the 0.030-0.045 mm amounts of expansion after cooling for examples 1, 3-6, and comparative example 5, in which the VA content was 0.3 mass % or greater.

This can be considered as follows. If the VA content is excessively small, the coating film resulting from the VA becomes scarce, and therefore sufficient effects cannot be obtained. In view of this, the VA content is preferably 0.3 mass % or greater, and more preferably, 0.5 mass % or greater.

It can also be seen from Table 4 that in comparative example 5, in which the content of the vinyl acetate (VA) was 3.5 mass % or greater, the remaining preservation characteristics were 80.2% and the regained preservation characteristics were 88.0%, which were smaller than the 85.4-86.9% remaining preservation characteristics and the 93.4-95.5% regained preservation characteristics for examples 1 and 3-6, in which the VA content was 3.0 mass % or smaller.

This can be considered as follows. If the VA content is excessively large, the coating film resulting from the VA becomes dense, preventing the charge and discharge reaction at the negative electrode. In view of this, the VA content is preferably 3.0 mass % or smaller, and more preferably, 2.0 mass % or smaller.

### EXAMPLE 7

A non-aqueous electrolyte secondary cell according to example 7 was prepared in the same manner as example 1 except that the vinyl ethylene carbonate (VEC) was 1.0 mass % and the vinyl acetate (VA) was 1.0 mass %.

### EXAMPLE 8

A non-aqueous electrolyte secondary cell according to example 8 was prepared in the same manner as example 7 except that the VEC was 2.5 mass %.

### EXAMPLE 9

A non-aqueous electrolyte secondary cell according to example 9 was prepared in the same manner as example 7 except that the VEC was 3.5 mass %.

### COMPARATIVE EXAMPLE 6

A non-aqueous electrolyte secondary cell according to comparative example 6 was prepared in the same manner as example 7 except that the VEC was not added (the amount of addition thereof was 0.0 mass %).

### COMPARATIVE EXAMPLE 7

A non-aqueous electrolyte secondary cell according to comparative example 7 was prepared in the same manner as example 7 except that the amount of addition of the VEC was 0.5 mass %.

### COMPARATIVE EXAMPLE 8

A non-aqueous electrolyte secondary cell according to comparative example 8 was prepared in the same manner as example 7 except that the amount of addition of the VEC was 4.0 mass %.

Each of the above-prepared cells was subjected to a high-temperature characteristics test under the above conditions. The results are shown in Table 5.

TABLE 5

| | | Amount of | Amount of | Remaining | Regained |
|---|---|---|---|---|---|
| | Amount of | expansion | expansion | preservation | preservation |
| | addition of | after | after | char- | char- |
| | VEC | preservation | cooling | acteristics | acteristics |
| | (mass %) | (mm) | (mm) | (%) | (%) |
| Com. | 0.0 | 0.402 | 0.102 | 80.7 | 89.4 |
| Ex. 6 | | | | | |
| Com. | 0.5 | 0.389 | 0.095 | 80.9 | 89.2 |
| Ex. 7 | | | | | |
| Ex. 7 | 1.0 | 0.104 | 0.039 | 85.4 | 93.3 |
| Ex. 2 | 1.5 | 0.049 | 0.039 | 84.9 | 92.9 |
| Ex. 4 | 2.0 | 0.040 | 0.035 | 86.9 | 95.5 |
| Ex. 8 | 2.5 | 0.040 | 0.035 | 85.9 | 93.3 |
| Ex. 9 | 3.5 | 0.044 | 0.041 | 85.2 | 93.1 |
| Com. | 4.0 | 0.058 | 0.044 | 80.3 | 87.9 |
| Ex. 8 | | | | | |

From Table 5, it can be seen that in comparative examples 6 and 7, in which the content of the vinyl ethylene carbonate (VEC) was 0.5 mass % or smaller, the amounts of cell expansion after preservation were respectively 0.402 mm and 0.389 mm and the amounts of cell expansion after cooling were respectively 0.102 mm and 0.095 mm, which were greater than the 0.040-0.104 mm amounts of cell expansion after preservation and the 0.035-0.044 mm amounts of cell expansion after cooling for examples 2, 4, 7-9, and comparative example 8, in which the VEC content was 1.0 mass % or greater.

This can be considered as follows. If the VEC content is excessively small, the coating film resulting from the VEC becomes scarce, and therefore sufficient effects cannot be obtained. In view of this, the VEC content is preferably 1.0 mass % or greater, and more preferably, 1.5 mass % or greater.

It can also be seen from Table 5 that in comparative example 8, in which the content of the vinyl ethylene carbonate (VEC) was 4.0 mass % or greater, the remaining preservation characteristics were 80.3% and the regained preservation characteristics were 87.9%, which were smaller than the 84.9-86.9% remaining preservation characteristics and the 92.9-95.5% regained preservation characteristics of examples 2, 4, 7-9, in which the VEC content was 3.5 mass % or smaller.

This can be considered as follows. If the VEC content is excessively large, the coating film resulting from the VEC becomes dense, preventing the charge and discharge reaction at the negative electrode. In view of this, the VEC content is preferably 3.5 mass % or smaller.

### EXAMPLE 10

A non-aqueous electrolyte secondary cell according to example 10 was prepared in the same manner as example 1 except that as a non-aqueous solvent, ethylene carbonate (EC), propylene carbonate (PC), and diethyl carbonate (DEC) were mixed at a volume ratio of 40:10:50 (25° C.), and as electrolytic salt, LiPF₆ was dissolved in the non-aqueous solvent at 1 M (mole/liter), and 2.0 mass % of vinyl ethylene carbonate (VEC) and 1.0 mass % of vinyl acetate (VA) were added.

### EXAMPLE 11

A non-aqueous electrolyte secondary cell according to example 11 was prepared in the same manner as example 10 except that as a non-aqueous solvent, ethylene carbonate (EC), propylene carbonate (PC), and diethyl carbonate (DEC) were mixed at a volume ratio of 40:20:40 (25° C.).

### EXAMPLE 12

A non-aqueous electrolyte secondary cell according to example 12 was prepared in the same manner as example 10 except that as a non-aqueous solvent, ethylene carbonate (EC), propylene carbonate (PC), and diethyl carbonate (DEC) were mixed at a volume ratio of 40:30:30 (25° C.).

### EXAMPLE 13

A non-aqueous electrolyte secondary cell according to example 13 was prepared in the same manner as example 10 except that as a non-aqueous solvent, ethylene carbonate (EC), propylene carbonate (PC), and diethyl carbonate (DEC) were mixed at a volume ratio of 40:40:20 (25° C.).

### EXAMPLE 14

A non-aqueous electrolyte secondary cell according to example 14 was prepared in the same manner as example 10 except that as a non-aqueous solvent, ethylene carbonate (EC), propylene carbonate (PC), and diethyl carbonate (DEC) were mixed at a volume ratio of 50:50:0 (25° C.).

### EXAMPLE 15

A non-aqueous electrolyte secondary cell according to example 15 was prepared in the same manner as example 10 except that as a non-aqueous solvent, ethylene carbonate (EC), propylene carbonate (PC), and diethyl carbonate (DEC) were mixed at a volume ratio of 40:60:0 (25° C.).

### COMPARATIVE EXAMPLE 9

A non-aqueous electrolyte secondary cell according to comparative example 9 was prepared in the same manner as example 10 except that as a non-aqueous solvent, ethylene carbonate (EC), propylene carbonate (PC), and diethyl carbonate (DEC) were mixed at a volume ratio of 0:40:60 (25° C.).

### COMPARATIVE EXAMPLE 10

A non-aqueous electrolyte secondary cell according to comparative example 10 was prepared in the same manner as example 13 except that as a non-aqueous solvent, ethylene carbonate (EC), propylene carbonate (PC), and diethyl carbonate (DEC) were mixed at a volume ratio of 35:65:0 (25° C.).

Each of the above-prepared cells was subjected to a high-temperature characteristics test under the above conditions. The results are shown in Table 6.

TABLE 6

| | | | | Amount of | Amount of | | |
|---|---|---|---|---|---|---|---|
| | | | | expansion | expansion | Remaining | Regained |
| | Amount of | Amount of | Amount of | after | after | preservation | preservation |
| | PC | EC | DEC | preservation | cooling | characteristics | characteristics |
| | (vol. %) | (vol. %) | (vol. %) | (mm) | (mm) | (%) | (%) |
| Com. Ex. 9 | 0 | 40 | 60 | 0.511 | 0.154 | 74.3 | 81.5 |
| Ex. 10 | 10 | 40 | 50 | 0.108 | 0.047 | 85.7 | 92.1 |
| Ex. 11 | 20 | 40 | 40 | 0.040 | 0.035 | 86.9 | 95.5 |
| Ex. 12 | 30 | 40 | 30 | 0.039 | 0.034 | 87.1 | 95.6 |
| Ex. 13 | 40 | 40 | 20 | 0.087 | 0.041 | 86.6 | 94.3 |
| Ex. 14 | 50 | 50 | 0 | 0.105 | 0.062 | 85.2 | 92.8 |
| Ex. 15 | 60 | 40 | 0 | 0.114 | 0.072 | 83.4 | 91.7 |
| Com. Ex. | 65 | 35 | 0 | 0.379 | 0.125 | 70.2 | 80.8 |
| 10 | | | | | | | |

From Table 6, it can be seen that in comparative example 9, in which no propylene carbonate (PC) was added, the amount of expansion after preservation was 0.511 mm and the amount of expansion after cooling was 0.154 mm, which were greater than those in examples 13-18, in which the PC content was from 10 to 60 volume % and the amounts of expansion after preservation were from 0.039 to 0.114 mm and the amounts of expansion after cooling were from 0.034 to 0.072 mm. It can also be seen that in comparative example 9, the remaining preservation characteristics were 74.3% and the regained preservation characteristics were 81.5%, which were smaller than the 83.4-87.1% remaining preservation characteristics and the 91.7-95.6% regained preservation characteristics of examples 10-15, in which the PC content was from 10 to 60 volume % or smaller.

It can also be seen from Table 6 that in comparative example 10, in which the content of the propylene carbonate (PC) was 65 volume %, the amount of expansion after preservation was 0.379 mm and the amount of expansion after cooling was 0.125 mm, which were greater than the 0.039-0.114 mm amounts of expansion after preservation and the 0.034-0.072 mm amounts of expansion after cooling of examples 13-18, in which the PC content was from 10 to 60 volume %. It can also be seen that in comparative example 9, the remaining preservation characteristics were 70.2% and the regained preservation characteristics were 80.8%, which were smaller than the 83.4-87.1% remaining preservation characteristics and the 91.7-95.6% regained preservation characteristics of examples 10-15, in which the PC content was 10-60 volume %.

This can be considered as follows. If the PC content is excessively small, the ethylene carbonate reacts with the negative electrode to generate gas, thereby increasing the amount of expansion, and also, the coating film resulting from the reaction with the negative electrode interrupts the discharge reaction at the negative electrode, thereby reducing the discharge characteristics. On the other hand, if the PC content is excessively large, the reaction between the PC and the negative electrode cannot be inhibited even if vinyl acetate and vinyl ethylene carbonate are contained, and thus gas is generated, thereby increasing the amount of expansion, and also, the decomposition product causes the internal resistance of the cell to increase, resulting in a decrease in the preservation characteristics. In view of this, the PC content is preferably from 10 to 60 volume %, and more preferably, from 20 to 40 volume %.

### SUPPLEMENTARY REMARKS

In addition to propylene carbonate, as the non-aqueous solvent, ethylene carbonate, diethyl carbonate, ethyl methyl carbonate, γ-butyrolactone, dimethyl carbonate, tetrahydrofuran, 1,2-dimethoxyethane, 1,3-dioxolane, 2-methoxy tetrahydrofuran, diethyl ether, and the like can be used.

As the electrolytic salt, other than LiPF₆, any of LiBF₄, LiN(C₂F₅SO₂)₂, LiN(CF₃SO₂)₂, LiClO₄, and the like can be used alone or in a mixture of the foregoing.

Further, as the outer casing, other than the above aluminum laminate outer casing, other outer casings that change shape upon a slight increase in the internal cell pressure can be used. In the case where, as the outer casing, other outer casings than the aluminum laminate outer casing are used, the resin layers are not limited to polypropylene; for example, polyolefin-based polymer such as polyethylene, polyester-based polymer such as polyethylene terephthalate, polyvinylidene-based polymer such as polyvinylidene fluoride and polyvinylidene chloride, polyamide-based polymer such as nylon 6, nylon 66, and nylon 7, and the like can be used. Also, the structure of the aluminum laminate outer casing is not limited to the above five-layered structure.

Other than the laminate outer casing, it is possible to use a cylindrical outer casing can, a coin-shaped outer casing can, and the like.

What is claimed is:

1. A non-aqueous electrolyte secondary cell comprising:
a positive electrode;
a negative electrode;
a non-aqueous electrolyte having a non-aqueous solvent and an electrolytic salt; and
an outer casing for housing the positive electrode, the negative electrode, and the non-aqueous electrolyte, wherein:
the non-aqueous solvent has propylene carbonate at from 10 to 60 volume %; and
the non-aqueous electrolyte further has, as well as the non-aqueous solvent, vinyl acetate at from 0.3 to 3.0 mass % and vinyl ethylene carbonate at from 1.0 to 3.5 mass %.

2. The non-aqueous electrolyte secondary cell according to claim 1, wherein the content of the propylene carbonate is from 20 to 40 volume %.

3. The non-aqueous electrolyte secondary cell according to claim 1, wherein the content of the vinyl acetate is from 0.5 to 2.0 mass %.

4. The non-aqueous electrolyte secondary cell according to claim 1, wherein the content of the vinyl ethylene carbonate is from 1.5 to 3.5 mass %.

5. The non-aqueous electrolyte secondary cell according to claim 1, wherein the outer casing is made of a film composed of a metal layer and a resin layer laminated atop one another.
